(19) United States
(12) Patent Application Publication
(10) Pub. No.: US 2026/0265492 A1
(43) Pub. Date: Sep. 10, 2026

(54) MELT ADDITIVES FOR LOW SURFACE-ENERGY APPLICATIONS

(71) Applicant: 3M INNOVATIVE PROPERTIES COMPANY, St. Paul, MN (US)

(72) Inventors: Georgiy Teverovskiy, St. Louis Park, MN (US); Maria A. Appeaning, St. Louis Park, MN (US); Colin A. Grambow, Minneapolis, MN (US)

(21) Appl. No.: 18/714,496

(22) PCT Filed: Oct. 11, 2022
(86) PCT No.: PCT/IB2022/059744

§ 371 Date: May 29, 2024

Related U.S. Application Data
(60) Provisional application No. 63/285,702, filed on Dec. 3, 2021.

(51) Int. Cl. C08K 5/435; B29C 48/00; B29C 48/08; B29K 67/00; B29K 105/00; B29L 7/00; C09J 7/40; C09J 183/04

(52) U.S. Cl. CPC C08K 5/435; B29C 48/022; B29C 48/08; C09J 7/405; C09J 183/04; B29K 2067/003; B29K 2105/0067; B29L 2007/008; C09J 2467/00; C09J 2483/00

(57) ABSTRACT

Fluorine-free and silicone-free extruded release liner for silicone adhesives that is stable at high temperatures, has advantageous surface energy characteristics, has minimal impact on adhesive performance, and has minimal environmental impact comprising a composition that includes a thermoplastic polymer and a polymer melt additive represented by the structure (I) where Y is a bivalent carbonyl- or sulfonyl-substituted arylene or aliphatic group, each Z is independently a single bond or an arylene group, and each Q is independently a hydrocarbyl or a heterohydrocarbyl group. Methods of preparing such compositions and additives are provided.

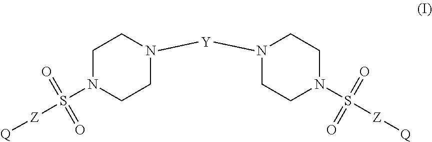

### TECHNICAL FIELD

The present disclosure broadly relates to thermoplastic compositions including alkyl sulfonamides.

### BACKGROUND

According to the Pressure-Sensitive Tape Council, pressure-sensitive adhesives (“PSAs”) are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). Materials that are merely sticky or adhere to a surface do not constitute a PSA; the term PSA encompasses materials with additional viscoelastic properties.

These requirements for pressure-sensitive adhesives are assessed generally by means of tests which are designed to individually measure tack, adhesion (i.e., peel strength), and cohesion (i.e., shear holding power), as noted by A. V. Pocius in Adhesion and Adhesives Technology: An Introduction, 2.sup.nd Ed., Hanser Gardner Publication, Cincinnati, Ohio, 2002. These measurements taken together constitute the balance of properties often used to characterize a PSA.

Articles having release characteristics may be used in a variety of applications. For example, adhesive-coated articles (e.g., coated with a pressure-sensitive-adhesive), such as tapes, die-cuts, labels, and the like, often employ a release coating as a part of their structure. The purpose of the release coating is typically to provide a surface to which the adhesive coating does not permanently adhere.

### SUMMARY

The present disclosure is directed to fluorine-free and silicone-free extruded release liners for silicone adhesives that are stable at high temperatures, have advantageous surface energy characteristics, have minimal impact on adhesive performance, and have minimal environmental impact comprising a composition that includes a thermoplastic polymer and an additive of structure

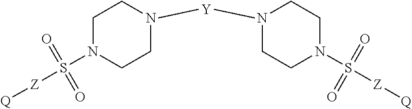

where Y is a bivalent carbonyl- or sulfonyl-substituted arylene or aliphatic group, each Z is independently a single bond or an arylene group, and each Q is independently a hydrocarbyl or a heterohydrocarbyl group. Methods of preparing such compositions and additives are provided.

As used herein:
“essentially no” amount of a material in a composition may be substituted with “less than 5 weight percent”, “less than 4 weight percent”, “less than 3 weight percent”, “less than 2 weight percent”, “less than 1 weight percent”, “less than 0.5 weight percent”, “less than 0.1 weight percent”, or “none”;
“pressure sensitive adhesive” or “PSA” means materials having at least the following properties: a) tacky surface, b) the ability to adhere with no more than finger pressure, c) the ability to adhere without activation by any energy source, d) sufficient ability to hold onto the intended adherend, and preferably e) sufficient cohesive strength to be removed cleanly from the adherend; which materials typically meet the Dahlquist criterion of having a storage modulus at 1 Hz and room temperature of less than 0.3 MPa; and

All scientific and technical terms used herein have meanings commonly used in the art unless otherwise specified.

As used in this specification and the appended claims, past tense verbs, such as, for example, “coated,” and are intended to represent structure, and not to limit the process used to obtain the recited structure, unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open-ended sense, and generally mean “including, but not limited to.” It will be understood that the terms “consisting of” and “consisting essentially of” are subsumed in the term “comprising,” and the like.

Features and advantages of the present disclosure will be further understood upon consideration of the detailed description as well as the appended claims.

### DETAILED DESCRIPTION

Release coatings have been applied to surfaces by preparing the release components in solvent, coating the solution onto a desired surface, and drying to evaporate the solvent. One example of a release coating formed using a conventional solvent-based process is disclosed in U.S. Pat. No. 2,532,011 (Dahlquist et al.). Such solvent-based processes, however, have become increasingly less desirable due to special handling concerns associated therewith. Furthermore, conventional release materials are typically applied to a substrate in a coating step that is separate from the preparation of the substrate itself. In the present disclosure, the preparation of the substrate (i.e., backing) can be carried out simultaneously with the preparation of the release surface in a solventless co-extrusion process.

Partially fluorinated small molecule additives are known and have been used as Polymer Melt Additives (“PMAs”) in polyolefin, polyester, and polyamide co-extrusion. These PMAs impart, for example, static and dynamic water and oil repellency and soil resistance to the resulting nonwovens, fibers, and fabrics. U.S. Pat. No. 5,451,622 (Boardman, et al.) discloses the use of partially fluorinated amides in thermoplastic polymers to impart water and oil repellency to shaped articles, such as fibers and films and to thermoplastic mixtures of fluorochemical and thermoplastic polymer, such as polypropylene, and to the shaped articles thereof, such as fibers and films.

The incorporation of a partially fluorinated small molecule can allow for in situ functionalization of a bulk material, which may obviate the need for post-processing steps, such as, for example, UV cure and thermal treatment. Such modification may be exemplified in bulk polymer co-extrusions, coatings utilizing a polymeric binder, or combinations thereof. Furthermore, partially fluorinated small molecule additives have found utility as release materials for pressure sensitive adhesives for e-beam-stable release as coatings and are being investigated as low-adhesion backings and premium release liners in solid state/co-extrusion formulations to provide, inter alia, minimal-transfer liners for silicone adhesives enabling premium release features with minimal impact to adhesive performance and the global environment.

However, because fluorinated materials have come under intense regulatory scrutiny, it is also desirable to provide fluorine-free PMAs to enable water and oil repellent products wherein fluorochemical use is restricted or disallowed. The PMAs disclosed herein meet at least these criteria and are intended to replace fluorinated materials for use in such applications.

In one aspect, provided is a composition including a thermoplastic or thermoset polymer and a PMA represented by Formula I

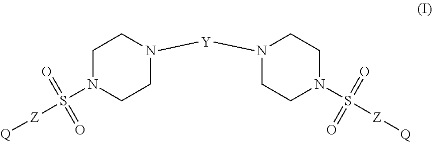

where Y is a bivalent carbonyl- or sulfonyl-substituted arylene or aliphatic group, each Z is independently a single bond or an arylene group, and each Q is independently a hydrocarbyl or a heterohydrocarbyl group.

In some embodiments, the PMA may be represented by Formula II

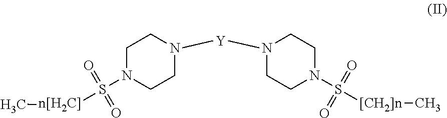

where Y is a carbonyl- or sulfonyl-substituted arylene group and each n is independently a whole number from 4 to 32, inclusive. In some preferred embodiments, the carbonyl- or sulfonyl-substituted arylene group is represented by the structure

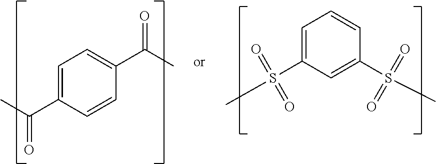

and each n is independently a whole number from 4 to 32, optionally 4 to 18, inclusive. PMAs useful in embodiments of the present disclosure may be prepared by methods known to those of ordinary skill in the relevant arts, such as, for example, the methods provided in the Examples section supra.

Polymers useful in embodiments of the present disclosure may include both thermoplastic and thermoset polymers. Preferred thermoplastic polymers include polyesters, such as, for example, polyethylene terephthalate, polybutylene terephthalate, polyphenylene terephthalates, as well as thermoplastic polyurethanes, polyolefins, and renewable and biogradable polyesters, such as those derived from polylactide (“PLA”) and polybutylenesuccinate (“PBS”), polymers derived from copolyester resins available under the trade designation SPECTAR from Eastman Chemical Company, Kingsport, Tennessee, USA, and combinations thereof.

A polymer composition of the present disclosure can be melted or shaped, for example by extrusion or molding, to produce shaped articles, such as fibers, films and molded articles whose surfaces exhibit excellent oil- and water-repellency. The repellent polymer composition is especially useful in the preparation of nonwoven fabrics used in medical gowns and drapes, where repellency to bodily fluids is mandated. Films made from repellent polymer compositions of this invention are useful, for example, for moisture and/or grease-resistant packaging, release liners, and multilayer constructions (e.g., laminates). In preferred embodiments, the polymer composition comprises essentially no fluorine.

Shaped articles (e.g., fibers, films, and molded or extruded articles) prepared from compositions of the present disclosure can be made, e.g., by blending or otherwise uniformly mixing the PMAs of Formula I and a polymer, such as those described supra, for example by intimately mixing the PMA with pelletized or powdered polymer, and melt extruding the mixture into shaped articles such as pellets, fibers, or films by known methods. The PMA can be mixed per se with the polymer or can be mixed with the polymer in the form of a “masterbatch” (i.e., concentrate) of the PMA in the polymer. Masterbatches typically contain from about 10% to about 25% by weight of the PMA. Also, an organic solution of the PMA may be mixed with the powdered or pelletized polymer, the mixture dried to remove solvent, then melted and extruded into the desired shaped article. Alternatively, molten PMA (as a compound(s) or masterbatch) can be injected into a molten polymer stream to form a blend just prior to extrusion into the desired shaped article. When using thermoset resins, such as epoxy resins, urethanes and acrylates, the PMA may be mixed with the resin and cured by application of heat. Preferably such thermoset resins may be processed by reactive extrusion techniques such as are taught in U.S. Pat. No. 4,619,976 (Kotnour) and U.S. Pat. No. 4,843,134 (Kotnour).

Thermoplastic compositions containing the compounds of Formula I (i.e., PMA) may be used to provide release properties to films. The disclosed PMAs are melt processible, i.e., suffer substantially no degradation under the melt processing conditions used to form the films. The amount of PMA in the composition is that amount sufficient to produce a shaped article having a surface with the desired release properties. Thermoplastic compositions containing the PMAs of Formula I and Formula II may commonly include 0.1 wt. % to 10 wt. %, optionally, 0.5 wt. % to 7 wt %, optionally 1 wt. % to 3 wt. % of the PMA relative to the total weight of the thermoplastic to which they are added.

The present disclosure focuses on the development of a fluorine-free and silicone-free extruded release liner for silicone adhesives that is stable at high temperatures, has advantageous surface energy characteristics, has minimal impact on adhesive performance (silicone-containing release liners may transfer silicone material and can negatively impact end use case), and has minimal environmental impact.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Unless otherwise indicated, materials used in the examples were obtained from commercial suppliers (e.g., Aldrich Chemical Co., Milwaukee, Wisconsin) and/or made by known methods. Materials prepared in the examples were analyzed by NMR spectroscopy and were consistent with the given structures.

### Materials Used in the Examples

| Abbreviation | Description and Source |
|---|---|
| ESP | 1-(ethylsulfonyl)piperazine, obtained as product code 62937-96-6 |
| | from Combi-Blocks, Inc., San Diego, California |
| BSP | 1-(butylsulfony1)piperazine, obtained as product code 926206- |
| | 14-6 from Combi-Blocks, Inc., San Diego, California |
| t-BBSC | 4-tert-butylbenzenesulfonyl chloride, obtained as product code |
| | 269670 from Millipore Sigma, Burlington, Massachusetts |
| ODSC | 1-octadecanesulfonyl chloride, obtained as product code |
| | L0240614 from Alfa Aesar, Ward Hill, Massachusetts |
| HDSC | 1-hexadecanesulfonyl chloride, obtained as product code A14396 |
| | from Alfa Aesar, Ward Hill, Massachusetts |
| OSC | 1-octanesulfonyl chloride, obtained as product code A15440-18 |
| | from Alfa Aesar, Ward Hill, Massachusetts |
| NMODA | N-methyl-octadecylamine, obtained as product code M0912 from |
| | TCI America, Portland, Oregon |
| Piperazine | Piperazine, obtained as product code A15049 from Alfa Aesar, |
| | Ward Hill, Massachusetts |
| PTA Clear 62 | PET resin available as product code 41-5599-0286-5 from 3M |
| | Company, St. Paul, Minnesota |
| PCTg | Copolyester resin obtained under the trade designation |
| | “SPECTAR CLEAR COPOLYESTER VM318,” from Eastman |
| | Chemical Company, Kingsport, Tennessee |
| N,N-diisopropylethylamine | N,N-diisopropylethylamine, obtained from Millipore Sigma, |
| | Burlington, Massachusetts |
| Terephthaloyl chloride | Terephthaloyl chloride, obtained as product code 120871from |
| | Millipore Sigma, Burlington, Massachusetts |
| Benzene-1,3-disulfonyl | Benzene-1,3-disulfonyl chloride, obtained as product code |
| chloride | 444642 from Millipore Sigma, Burlington, Massachusetts |
| THF | Tetrahydrofuran, can be obtained from Millipore Sigma, |
| | Burlington, Massachusetts |
| PJ271 | A release liner obtained as product code PJ271 from Toray |
| | Corporation, Tokyo, Japan |
| FPET | A release liner containing a fluorinated release agent, prepared |
| | according to the procedure in U.S. Pat. No. 10/731,056 |
| 9741 | Fluoropolymer coated polypropylene release liner, available |
| | under the trade designation “3M SCOTCHPAK 9741” from 3M |
| | Company, St. Paul, Minnesota |
| GSA3 80/20 Adhesive | A solvent-free, high-tackifier, gentle-to-skin silicone adhesive |
| | prepared according to the procedure in published PCT |
| | application WO2019195145A1 |
| 3SAB | Clear polyester film, available under the trade designation |
| | “HOSTAPHAN 3SAB” from Mitsubishi Chemical America, |
| | Inc., Charlotte, North Carolina |
| BIO-PSA | Silicone adhesive, obtained under the trade designation “BIO- |
| | PSA 7-4560” from Dow Corning, Midland, Michigan |
| SPOx Adhesive | Silicone polyoxamide adhesive, available as product ID 41-4202- |
| | 7526-9 from 3M Company, St. Paul, Minnesota |

### Test Methods

### Determination of F Surface Concentration Via XPS

The example surfaces were examined using X-ray Photoelectron Spectroscopy (“XPS”) also known as Electron Spectroscopy for Chemical Analysis (“ESCA”) at an approximate photoelectron takeoff angle of 45° unless otherwise stated.

### Contact Angle Measurement

Water contact angles were measured using a Ramé-Hart goniometer (Ramé-Hart Instrument Co., Succasunna, NJ). Advancing (θ adv) and receding (θ rec) angles were measured as probe fluid was supplied via a syringe into or out of sessile droplets (drop volume ~10 μL). Measurements were taken at three different spots on each surface, and the reported measurements are the averages of the 9 values for each sample (3 measurements per spot, for advancing and receding independently).

Release Force of Adhesive Test Tape from Release Liner

The release force between the release liner and the Adhesive Test Tape of a laminate construction was measured using a 180-degree peel geometry according to the manufacturer's instructions as follows. An IMASS SP 2100 peel force tester (IMASS, Incorporated, Accord, Massachusetts) equipped with a 5.0-pound (2.27-kg) load cell was employed using the following parameters: Procedure A: A 1 inch (2.54 centimeters) wide test specimen, a peel rate of 90 inches/minute (228.6 cm/min), a 0.2 second delay before data acquisition, and a 2 second averaging time. The average of two test specimens was reported in grams/inches; and Procedure B: A 1 inch (2.54 centimeters) wide test specimen, a peel rate of 1500 inches/minute (3750 cm/min), a 0.1 second delay before data acquisition, and a 0.2 second averaging time. The average of two test specimens was reported in grams/inches.

Testing was done after aging according to the following conditions: A) twenty-one days at 22° C. (72° F.) and 50% Relative Humidity; B) twenty-one days at 50° C., followed by an equilibration at 22° C. (72° F.) and 50% Relative Humidity for a minimum of 24 hours before testing; C) twenty-one days at 22° C. (72° F.) and 50% Relative Humidity followed by 110° C. (230° F.) for 3 min followed by an equilibration at 22° C. (72° F.) and 50% Relative Humidity for a minimum of 24 hours before testing; D) seven days at 22° C. (72° F.) and 50% Relative Humidity; E) seven days at 50° C., followed by an equilibration at 22° C. (72° F.) and 50% Relative Humidity for a minimum of 24 hours before testing; F) twenty-eight days at 22° C. (72° F.) and 50% Relative Humidity; and G) twenty-eight days at 50° C., followed by an equilibration at 22° C. (72° F.) and 50% Relative Humidity for a minimum of 24 hours before testing.

### Peel Adhesion Strength

Samples were evaluated for peel adhesion strength after aging at the conditions described in the Release Force of Adhesive Test Tape from Release Liner test. Testing was done immediately after removal of the Test Adhesive from the release liner (within one minute) and applying the test tape to a clean glass plate using a 5 lb (2.3 kg) roller at 72° F. (22° C.) and 50% Relative Humidity. An IMASS SP 2100 Slip/Peel Tester (IMASS, Incorporated, Accord, Massachusetts) equipped with a 10 pound (4.54 kg) load cell was employed using the following parameters where indicated: A) one inch (2.54 cm) wide test specimen, peel rate of 12 inches/minute (40.48 cm/min), one second delay before data acquisition, 180° peel geometry, and a five second averaging time; or B) one inch (2.54 cm) wide test specimen, peel rate of 60 inches/minute (152.4 cm/min), one second delay before data acquisition, 180° peel geometry, and a five second averaging time. The average of two test specimens was reported in grams/cm. The control sample was evaluated without being exposed to a release liner and the peel adhesion was designated Peel Adhesion Strength Control below the respective table.

### Preparatory Examples

### Preparation of 1-(octylsulfonyl) piperazine

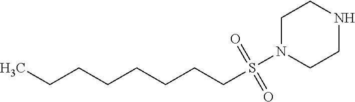 [SMILES: CCCCCCCCS(=O)(=O)N1CCNCC1]

To a 1-neck 2 L round bottom equipped with a magnetic stirrer, addition funnel and a Claisen adaptor with thermocouple and reflux condenser was added piperazine (190.2 g, 2207.9 mmol) and tetrahydrofuran (480 mL). Under a blanket of nitrogen gas, the reaction mixture was heated to 65° C. with continuous stirring. Once the reaction mixture reached 50° C., 1-octanesulfonyl chloride (141.9 mL, 723.9 mmol) was added via addition funnel at such a rate so as to maintain a temperature below 70° C. Upon completion of addition, the temperature was maintained at 70° C. and the reaction mixture was allowed to stir for 16 hr. The vessel was cooled to 50° C. and the contents were passed through a filter.

The clear filtrated liquid was collected back into the reaction flask and equipped with a vacuum distillation head equipped with a thermometer, water cooling, and a 500 mL receiver flask. THF was distilled from the reaction mixture under vacuum. The distillation head was removed and to the resultant solid mixture was added water (300 mL) and ethyl acetate (500 mL). The resulting biphasic mixture was heated to 50° C. with stirring for 5 min and then allowed to phase separate. The lower phase was removed, and the upper phase was washed 3× with water (300 mL), brine (500 mL), and dried over magnesium sulfate (250 g). The resulting yellow solution was filtered, solvent was removed via rotary evaporator and the solid material collected to afford 1-(octylsulfonyl) piperazine as a white solid.

### Preparation of 1-(hexadecylsulfonyl) piperazine

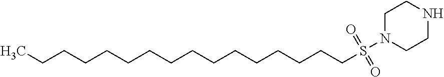 [SMILES: CCCCCCCCCCCCCCCCS(=O)(=O)N1CCNCC1]

To a 1-neck 2 L round bottom equipped with a magnetic stirrer, addition funnel and a Claisen adaptor with thermocouple and reflux condenser was added piperazine (120.5 g, 1398 mmol) and tetrahydrofuran (350 mL). Under a blanket of nitrogen gas, the reaction mixture was heated to 65° C. with continuous stirring. Once the reaction mixture reached 50° C., 1-hexadecanesulfonyl chloride (151 g, 466 mmol) in THF (250 mL) was added via addition funnel at such a rate so as to maintain a temperature below 70° C. Upon completion of addition, the temperature was maintained at 70° C. and the reaction mixture was allowed to stir for 16 hr. The vessel was cooled to 50° C. and the contents were passed through a filter. The clear filtrated liquid was collected back into the reaction flask and equipped with a vacuum distillation head equipped with a thermometer, water cooling, and a 500 mL receiver flask. THF was distilled from the reaction mixture under vacuum. The distillation head was removed and to the resultant solid mixture was added water (300 mL) and ethyl acetate (500 mL). The resulting biphasic mixture was heated to 50° C. with stirring for 5 min and then allowed to phase separate. The lower phase was removed, and the upper phase was washed 3× with water (300 mL), brine (500 mL), and dried over magnesium sulfate (250 g). The resulting yellow solution was filtered, solvent was removed via rotary evaporator and the solid material collected to afford 1-(hexadecylsulfonyl) piperazine as a white solid.

### Preparation of 1-(octadecylsulfonyl)piperazine

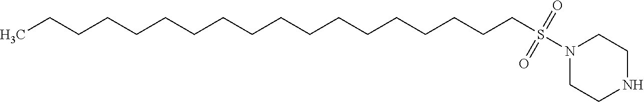 [SMILES: CCCCCCCCCCCCCCCCCCS(=O)(=O)N1CCNCC1]

To a 1-neck 2 L round bottom equipped with a magnetic stirrer, addition funnel, and a Claisen adapter with thermocouple and reflux condenser was added piperazine (59.48 g, 690.5 mmol) and tetrahydrofuran (250 mL). Under a blanket of nitrogen gas, the reaction mixture was heated to 65° C. with continuous stirring. Once the reaction mixture reached 50° C., 1-octadecanesulfonyl chloride (75 g, 212.5 mmol) in THF (150 mL) was added via addition funnel at such a rate so as to maintain a temperature below 70° C. Upon completion of addition, the temperature was maintained at 70° C. and the reaction mixture was allowed to stir for 16 hr. The vessel was cooled to 50° C. and the contents were passed through a filter. The cloudy filtrate was poured back into the reaction flask and equipped with a vacuum distillation head equipped with a thermometer, water cooling, and a 500 mL receiver flask. THF was distilled from the reaction mixture under vacuum. The distillation head was removed and to the resultant solid mixture was added water (300 mL) and ethyl acetate (500 mL). The resulting biphasic mixture was heated to 50° C. with stirring for 5 min and then allowed to phase separate. The lower phase was removed, and the upper phase was washed with hot water (300 mL, 35-45° C.). Solids began to crash out at which point the bottom phase was removed, the upper phase allowed to cool to r.t., and the resulting solids removed via filtration. The clear filtrate was poured back into the separatory funnel and washed 3× with water (300 mL), brine (500 mL), and dried over magnesium sulfate (250 g). The resulting yellow solution was filtered, solvent was removed via rotary evaporation and the solid material collected to afford 1-(octadecylsulfonyl) piperazine as an off-white solid.

### Preparation of 1-(4-tert-butylbenzenesulfonyl) piperazine

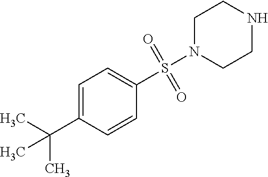 [SMILES: CC(C)(C)c1ccc(S(=O)(=O)N2CCNCC2)cc1]

To a 1-neck 2 L round bottom equipped with a magnetic stirrer, addition funnel and a Claisen adapter with thermocouple and reflux condenser was added piperazine (83.28 g, 966.79 mmol) and tetrahydrofuran (250 mL). Under a blanket of nitrogen gas, the reaction mixture was heated to 65° C. with continuous stirring. Once the reaction mixture reached 50° C., 4-tert-butylbenzenesulfonyl chloride (75 g, 322.26 mmol) in THF (150 mL) was added via addition funnel at such a rate so as to maintain a temperature below 70° C. Upon completion of addition, the temperature was maintained at 70° C. and the reaction mixture was allowed to stir for 16 hr. The vessel was cooled to 50° C. and the contents were passed through a filter. The clear filtrated was collected back into the reaction flask and equipped with a vacuum distillation head equipped with a thermometer, water cooling, and a 500 mL receiver flask. THF was distilled from the reaction mixture under vacuum. The distillation head was removed and to the resultant solid mixture was added water (300 mL) and ethyl acetate (500 mL). The resulting biphasic mixture was heated to 50° C. with stirring for 5 min and then allowed to phase separate. The lower phase was removed, and the upper phase was washed 3× with water (300 mL), brine (500 mL), and dried over magnesium sulfate (250 g). The resulting yellow solution was filtered, solvent was removed via rotary evaporation and the solid material collected to afford 1-(4-(tert-butyl)benzenesulfonyl) piperazine as a white solid.

### Preparation of Additive 1 (AD1)

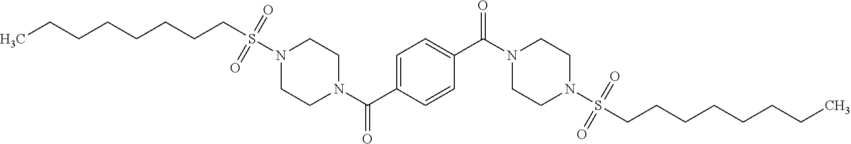 [SMILES: CCCCCCCCS(=O)(=O)N1CCN(C(=O)c2ccc(C(=O)N3CCN(S(=O)(=O)CCCCCCCC)CC3)cc2)CC1]

1-(octylsulfonyl) piperazine (54.56 g, 207.91 mmol), N,N-diisopropylethylamine (39.7 mL, 227.6 mmol) and ethyl acetate (210 mL) were added to a 1 L round bottom flask equipped with a magnetic stir bar, reflux condenser and addition funnel containing terephthaloyl chloride (21.0 g, 103.4 mmol) in ethyl acetate (50 mL) under nitrogen atmosphere. Terephthaloyl chloride solution was slowly added via addition funnel to the reaction mixture with vigorous stirring. Upon completion, the mixture was allowed to stir for 2 h at room temperature. Water (300 mL) was then added to the yellow mixture. The product was collected via filtration and further washed with water (500 mL three times) to afford AD1 as a white solid.

### Preparation of Additive 2 (AD2)

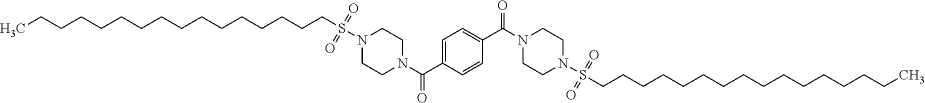 [SMILES: CCCCCCCCCCCCCCCCS(=O)(=O)N1CCN(C(=O)c2ccc(C(=O)N3CCN(S(=O)(=O)CCCCCCCCCCCCCCCC)CC3)cc2)CC1]

1-(hexadecylsulfonyl) piperazine (152.4 g, 406.9 mmol), N,N-diisopropylethylamine (79.1 mL, 453.3 mmol) and ethyl acetate (600 mL) were added to a 2 L round bottom flask equipped with a magnetic stir bar, reflux condenser and addition funnel containing terephthaloyl chloride (40.90 g, 201.5 mmol) in ethyl acetate (200 mL) under nitrogen atmosphere. Terephthaloyl chloride solution was slowly added via addition funnel to the reaction mixture with vigorous stirring. Upon completion, the mixture was allowed to stir for 16 h at room temperature. Water (300 mL) was then added to the mixture. The product was collected via filtration and further washed with water (500 mL three times) to afford AD2 as a white solid.

### Preparation of Additive 3 (AD3)

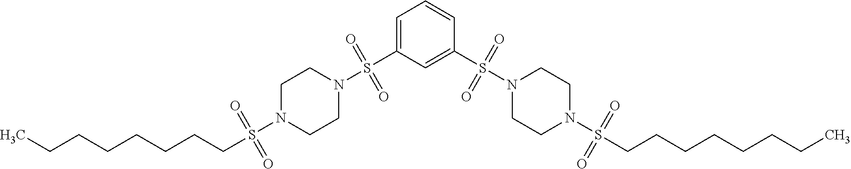 [SMILES: CCCCCCCCS(=O)(=O)N1CCN(S(=O)(=O)c2cccc(S(=O)(=O)N3CCN(S(=O)(=O)CCCCCCCC)CC3)c2)CC1]

1-(octylsulfonyl) piperazine (86.3 g, 328.8 mmol), N,N-diisopropylethylamine (39.7 mL, 227.6 mmol) and ethyl acetate (500 mL) were added to a 1 L round bottom flask equipped with a magnetic stir bar, reflux condenser and addition funnel containing benzene-1,3-disulfonyl chloride (45.0 g, 163.6 mmol) in ethyl acetate (100 mL) under nitrogen atmosphere. Benzene-1,3-disulfonyl chloride solution was slowly added via addition funnel to the reaction mixture with vigorous stirring. Upon completion, the mixture was allowed to stir for 2 h at room temperature. Water (300 mL) was then added to the yellow mixture. The product was collected via filtration and further washed with water (500 mL three times) to afford AD3 as a white solid.

### Preparation of Additive 4 (AD4)

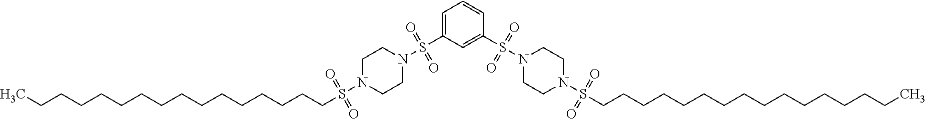 [SMILES: CCCCCCCCCCCCCCCCS(=O)(=O)N1CCN(S(=O)(=O)c2cccc(S(=O)(=O)N3CCN(S(=O)(=O)CCCCCCCCCCCCCCCC)CC3)c2)CC1]

1-(hexadecylsulfonyl) piperazine (111.7 g, 298.1 mmol), N,N-diisopropylethylamine (58.5 mL, 335.3 mmol) and ethyl acetate (400 mL) were added to a 2 L round bottom flask equipped with a magnetic stir bar, reflux condenser and addition funnel containing benzene-1,3-disulfonyl chloride (41.0 g, 149.0 mmol) in ethyl acetate (200 mL) under nitrogen atmosphere. Benzene-1,3-disulfonyl chloride solution was slowly added via addition funnel to the reaction mixture with vigorous stirring. Upon completion, the mixture was allowed to stir for 16 h at room temperature. Water (300 mL) was then added to the mixture. The product was collected via filtration and further washed with water (500 mL three times) to afford AD4 as a white solid.

### Preparation of Additive 5 (AD5)

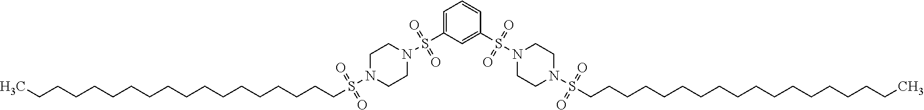 [SMILES: CCCCCCCCCCCCCCCCCCS(=O)(=O)N1CCN(S(=O)(=O)c2cccc(S(=O)(=O)N3CCN(S(=O)(=O)CCCCCCCCCCCCCCCCCC)CC3)c2)CC1]

1-(octadecylsulfonyl) piperazine (46.11 g, 114.5 mmol), N,N-diisopropylethylamine (22.5 mL, 12.8 mmol) and ethyl acetate (400 mL) were added to a 2 L round bottom flask equipped with a magnetic stir bar, reflux condenser and addition funnel containing benzene-1,3-disulfonyl chloride (15.75 g, 57.25 mmol) in ethyl acetate (200 mL) under nitrogen atmosphere. Benzene-1,3-disulfonyl chloride solution was slowly added via addition funnel to the reaction mixture with vigorous stirring. Upon completion, the mixture was allowed to stir for 16 h at room temperature. Water (300 mL) was then added to the mixture. The product was collected via filtration and further washed with water (500 mL three times) to afford AD5 as a white solid.

### Preparation of Additive 6 (AD6)

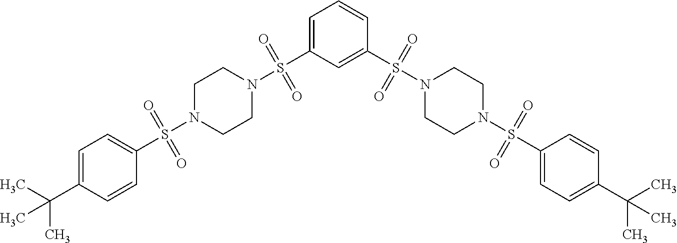 [SMILES: CC(C)(C)c1ccc(S(=O)(=O)N2CCN(S(=O)(=O)c3cccc(S(=O)(=O)N4CCN(S(=O)(=O)c5ccc(C(C)(C)C)cc5)CC4)c3)CC2)cc1]

1-(4-tert-butylbenzenesulfonyl) piperazine (74.65 g, 264.3 mmol), N,N-diisopropylethylamine (57.1 mL, 327.2 mmol) and ethyl acetate (400 mL) were added to a 2 L round bottom flask equipped with a magnetic stir bar, reflux condenser and addition funnel containing benzene-1,3-disulfonyl chloride (36 g, 130.9 mmol) in ethyl acetate (200 mL) under nitrogen atmosphere. Benzene-1,3-disulfonyl chloride solution was slowly added via addition funnel to the reaction mixture with vigorous stirring. Upon completion, the mixture was allowed to stir for 16 h at room temperature. Water (300 mL) was then added to the mixture. The product was collected via filtration and further washed with water (500 mL three times) to afford AD6 as a white solid.

### Preparation of Additive 7 (AD7)

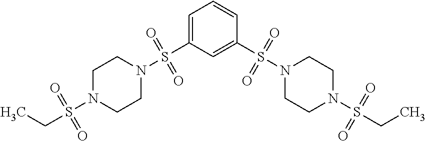 [SMILES: CCS(=O)(=O)N1CCN(S(=O)(=O)c2cccc(S(=O)(=O)N3CCN(S(=O)(=O)CC)CC3)c2)CC1]

1-(ethylsulfonyl) piperazine (75.91 g, 425.9 mmol), N,N-diisopropylethylamine (91.9 mL, 527.1 mmol) and ethyl acetate (500 mL) were added to a 1 L round bottom flask equipped with a magnetic stir bar, reflux condenser and addition funnel containing benzene-1,3-disulfonyl chloride (58.0 g, 210.8 mmol) in ethyl acetate (100 mL) under nitrogen atmosphere. Benzene-1,3-disulfonyl chloride solution was slowly added via addition funnel to the reaction mixture with vigorous stirring. Upon completion, the mixture was allowed to stir for 2 h at room temperature. Water (300 mL) was then added to the yellow mixture. The product was collected via filtration and further washed with water (500 mL three times) to afford AD7 as a white solid.

### Preparation of Additive 8 (AD8)

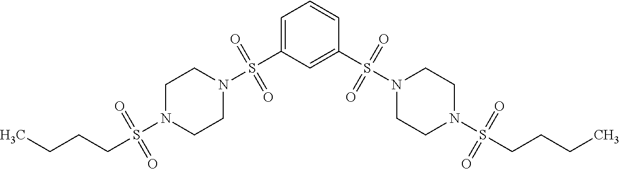 [SMILES: CCCCS(=O)(=O)N1CCN(S(=O)(=O)c2cccc(S(=O)(=O)N3CCN(S(=O)(=O)CCCC)CC3)c2)CC1]

1-(butylsulfonyl) piperazine (74.23 g, 359.8 mmol), N,N-diisopropylethylamine (77.7 mL, 445.3 mmol) and ethyl acetate (500 mL) were added to a 1 L round bottom flask equipped with a magnetic stir bar, reflux condenser and addition funnel containing benzene-1,3-disulfonyl chloride (49.0 g, 178.1 mmol) in ethyl acetate (100 mL) under nitrogen atmosphere. Benzene-1,3-disulfonyl chloride solution was slowly added via addition funnel to the reaction mixture with vigorous stirring. Upon completion, the mixture was allowed to stir for 2 h at room temperature. Water (300 mL) was then added to the yellow mixture. The product was collected via filtration and further washed with water (500 mL three times) to afford AD8 as a white solid.

### Preparation of Comparative Additive 1 (CA1)

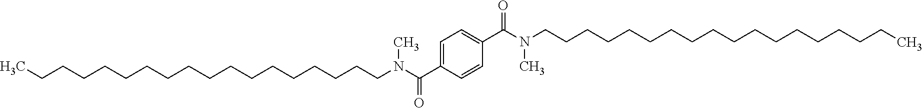 [SMILES: CCCCCCCCCCCCCCCCCCN(C)C(=O)c1ccc(C(=O)N(C)CCCCCCCCCCCCCCCCCC)cc1]

N-Methyl-Octadecylamine (50.27 g, 177.3 mmol), N,N-diisopropylethylamine (34.0 mL, 195.1 mmol) and ethyl acetate (150 mL) were added to a 1 L round bottom flask equipped with a magnetic stir bar, reflux condenser and addition funnel containing terephthaloyl chloride (18.0 g, 88.7 mmol) in ethyl acetate (100 mL) under nitrogen atmosphere. Terephthaloyl chloride solution was slowly added via addition funnel to the reaction mixture with vigorous stirring. Upon completion, the mixture was allowed to stir for 16 h at room temperature. Water (300 mL) was then added to the mixture. The product was collected via filtration and further washed with water (500 mL three times) to afford CA1 as a white solid.

### Preparation of Comparative Additive 2 (CA2)

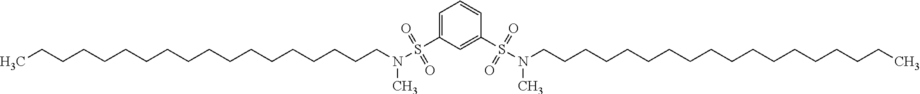 [SMILES: CCCCCCCCCCCCCCCCCCN(C)S(=O)(=O)c1cccc(S(=O)(=O)N(C)CCCCCCCCCCCCCCCCCC)c1]

N-Methyl-Octadecylamine (82.44 g, 290.8 mmol), N,N-diisopropylethylamine (55.8 mL, 319.9 mmol) and ethyl acetate (250 mL) were added to a 1 L round bottom flask equipped with a magnetic stir bar, reflux condenser and addition funnel containing benzene-1,3-disulfonyl chloride (40.0 g, 145.4 mmol) in ethyl acetate (100 mL) under nitrogen atmosphere. Benzene-1,3-disulfonyl chloride solution was slowly added via addition funnel to the reaction mixture with vigorous stirring. Upon completion, the mixture was allowed to stir for 16 h at room temperature. Water (300 mL) was then added to the mixture. The product was collected via filtration and further washed with water (500 mL three times) to afford CA2 as a white solid.

### Preparation of the Modified (Additive) PET Films

Modified PET films of a 24 mil thickness were extruded in a dual layer construction (1:9) top layer to bottom layer. The top layer (also referred to as the “skin” layer) was co-extruded with additive and PCTg, and the bottom layer consisted solely of PTA Clear 62 available from 3M Company, St. Paul, MN. The films were extruded using an 18 mm twin screw extruder equipped with three independent feeders. Feeder A contained the PTA Clear 62 resin pellets for the bottom layer, Feeder B contained PCTg for the top layer, and Feeder C contained additive for incorporation into the top layer. The CE-A material is a two-layer construction with PCTg as the top layer with no additive present and PTA Clear 62 as the bottom layer (i.e., 10% PCTg and 90% PTA Clear 62). CE-B, CE-C, and EX-1 to EX-8 included additive in the PCTg layer (2.5 wt. % relative to the total weight of the thermoplastic in the top layer), as indicated in Table 1. Conditions: The 5 inch by 5 inch squares were simultaneously biaxially oriented at a stretching ratio of 3.35 in the machine direction and 3.58 in the transverse direction with preheating temperatures at 96° C. for 15 s and thermally set at 212° C. for 15 seconds.

Examples were tested according to the Contact Angle Measurements procedures. Results are reported in Table 1 below.

TABLE 1
Contact Angle Measurements

| | | Θ ADV | Θ REC | Θ ADV | Θ REC |
|---|---|---|---|---|---|
| Film | Additive | Water | Water | Hexadecane | Hexadecane |
| CE-A | — | 85° | 66° | <10° | <10° |
| CE-B | CA1 | 86° | 64° | 24° | <10° |
| CE-C | CA2 | 3° | 71° | 33° | 3° |
| EX-1 | AD1 | 108° | 87° | 37° | 35° |
| EX-2 | AD2 | 113° | 106° | 42° | 37° |
| EX-3 | AD3 | 109° | 108° | 38° | 35° |
| EX-4 | AD4 | 110° | 104° | 39° | 35° |
| EX-5 | AD5 | 110° | 98° | 46° | 44° |
| EX-6 | AD6 | 83° | 62° | <10° | <10° |
| EX-7 | AD7 | 71° | 65° | 19° | <10° |
| EX-8 | AD8 | 94° | 94° | 38° | 37° |

TABLE 2
Release Force of Gentle-to-Skin Adhesive

| | Release Force (g/cm) Procedure A | | | Release Force (g/cm) Procedure B | | |
|---|---|---|---|---|---|---|
| Example | Condition A | Condition B | Condition C | Condition A | Condition B | Condition C |
| PJ271 | 55.4 | 57.9 | 338 | 351 | 437 | 1039 |
| FPET | 165 | 178 | 197 | 269 | 381 | 368 |
| EX-1 | 274.1 | 687 | 164 | 706 | 1247 | 732 |
| EX-2 | 87.9 | 435.9 | 192 | 653 | 965 | 881 |
| EX-3 | 92.7 | 149 | 136 | 582 | 711 | 620 |
| EX-4 | 59.4 | 120 | 106 | 500 | 599 | 617 |

### BIO-PSA Test Adhesive Preparation

BIO-PSA (50% solids in heptane) was wet cast onto the novel films as well as comparative examples at 1.6 Mil dry thickness and dried for 10 min at 70° C. followed by lamination with 3SAB film. A control sample (“CS”) was also prepared by wet casting the adhesive solution onto 3SAB film directly. The test tape/release film test samples (one inch wide by eight-inch long strips) were cut out from the rest of the test tape/release film constructions and fully laminated using two complete passes of a 2 kg rubber roller.

TABLE 3
Release Force and Peel Adhesion of BIO-PSA Adhesive

| | Release Force (g/cm) | | Sample Peel Adhesion | |
|---|---|---|---|---|
| | Procedure A | | Strength* (g/cm) Parameters A | |
| Example | Condition D | Condition E | Condition D | Condition |
| PJ271 | 269 | 137 | 1534 | 1456 |
| 9741 | 757 | 1532 | 1597 | 1453 |
| EX-1 | 171 | 186 | 1353 | 1355 |
| EX-2 | 144 | 147 | 1338 | 1293 |
| EX-3 | 135 | 137 | 1384 | 1325 |
| EX-4 | 212 | 251 | 1296 | 1321 |

*Peel Adhesion Strength Control BIO-PSA: 1384 g/cm

### SPOx Adhesive Test Preparation

SPOx Adhesive (Lot 30003) was coated onto 2 Mil 3SAB Mitsubishi polyester film at a wet gap of about 11 mils and dried for 10 min at 70° C. The respective liner constructions were then laminated onto the adhesive using two complete passes of a 2 kg rubber roller. Control sample was tested without prior exposure to liner for peel adhesion strength.

TABLE 4
Release Force and Peel Adhesion of SPOx Adhesive

| | Release Force (g/cm) | | Sample Peel Adhesion | |
|---|---|---|---|---|
| | Procedure A | | Strength* (g/cm) Parameters B | |
| Example | Condition F | Condition G | Condition F | Condition |
| PJ271 | 25.7 | 38.4 | 5024 | 4961 |
| EX-1 | 40.6 | 56.4 | 4790 | 5408 |
| EX-2 | 31.0 | 42.9 | 4778 | 5329 |
| EX-3 | 51.8 | 65.8 | 5060 | 5245 |
| EX-4 | 27.9 | 43.4 | 4884 | 5215 |

*Peel Adhesion Strength Control SPOx Adhesive: 5440 g/cm

### Determination of F Surface Concentration Via XPS

No fluorochemical was detected for any examples.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A composition comprising:
a thermoplastic polymer; and
a polymer melt additive represented by the structure 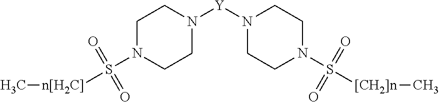
wherein
Y is a carbonyl- or sulfonyl-substituted arylene group and each n is independently a whole number from 4 to 32, inclusive.

2. (canceled)

3. The composition of claim 1, wherein the thermoplastic polymer comprises a polyethylene terephthalate film.

4. The composition of claim 1, wherein the carbonyl- or sulfonyl-substituted arylene group is represented by the structure

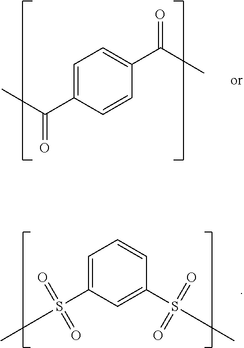

5. The composition of claim 1, wherein n is a whole number from 4 to 18, inclusive.

6. The composition of claim 1, wherein the composition comprises essentially no fluorine.

7. An extruded article comprising the composition of claim 1.

8. The extruded article of claim 7, wherein the extruded article is a film.

9. A laminate comprising the film of claim 8.

10. The laminate of claim 9, further comprising an adhesive.

11. The laminate of claim 10, wherein the adhesive comprises a silicone adhesive.

12. The laminate of claim 10, wherein the adhesive is a pressure-sensitive adhesive.

13. A method of preparing a composition, the method comprising:
combining a thermoplastic polymer with a polymer melt additive to provide the composition, the polymer melt additive represented by the structure 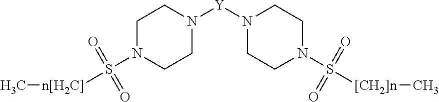
wherein
Y is a carbonyl- or sulfonyl-substituted arylene group and each n is independently a whole number from 4 to 32, inclusive.

14. (canceled)

15. The method of claim 13, wherein the thermoplastic polymer comprises a polyethylene terephthalate film.

16. The method of claim 13, wherein the carbonyl- or sulfonyl-substituted arylene group is represented by the structure

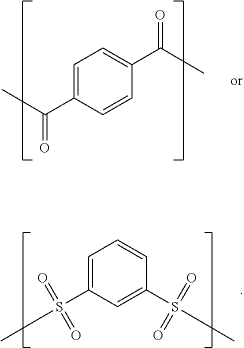

17. The method of claim 13, wherein n is a whole number from 4 to 18, inclusive.

18. The method of claim 13, wherein combining comprises extruding.

19. The method of claim 13, wherein the composition comprises 0.1 wt. % to 10 wt. %, optionally 1 wt. % to 3 wt. % of the polymer melt additive relative to the weight of the thermoplastic polymer.

20. The method of claim 13, wherein the composition comprises essentially no fluorine.
